(19) United States
(12) Patent Application Publication
(10) Pub. No.: US 2024/0174443 A1
(43) Pub. Date: May 30, 2024

(54) TRANSPORT DEVICE, AUTOMATED GUIDED VEHICLE, TRANSPORT METHOD, CONTROL DEVICE, CONTROL METHOD AND STORAGE MEDIUM

(71) Applicants: KABUSHIKI KAISHA TOSHIBA, Tokyo (JP); TOSHIBA INFRASTRUCTURE SYSTEMS & SOLUTIONS CORPORATION, Kawasaki-shi (JP)

(72) Inventors: Daisuke YAMAMOTO, Kawasaki (JP); Akihiro MORI, Kawasaki (JP); Akihito TERADA, Yokohama (JP); Daisuke KOBAYASHI, Yokohama (JP); Yusuke ITO, Yokohama (JP); Takuya MIYAMOTO, Kawasaki (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi (JP)

(21) Appl. No.: 18/518,663

(22) Filed: Nov. 24, 2023

(30) Foreign Application Priority Data
Nov. 25, 2022 (JP) 2022-188653

(51) Int. Cl. B65G 1/137; B60P 1/44

(52) U.S. Cl. CPC B65G 1/1371; B60P 1/4428; B65G 1/0492

(57) ABSTRACT

According to one embodiment, a transport device includes a main part, a wheel, and a reader. The main part supports or pulls an object. The wheel is mounted to the main part, and rolls over a traveling surface. The reader is fixed with respect to the main part, and reads an identifier in a direction tilted with respect to a first direction and a second direction. The first direction is along the traveling surface, and the second direction is perpendicular to the traveling surface. The identifier is mounted to a surface, which crosses the first direction, of the object. A position of an area of the surface read by the reader changes along the second direction as the transport device moves in the first direction.

### CROSS-REFERENCE TO RELATED APPLICATIONS

This application is based upon and claims the benefit of priority from Japanese Patent Application No. 2022-188653, filed on Nov. 25, 2022; the entire contents of which are incorporated herein by reference.

### FIELD

Embodiments described herein relate generally to a transport device, an automated guided vehicle, a transport method, a control device, a control method and a storage medium.

### BACKGROUND

There is a transport device that moves along a floor surface and transports an object. For such a transport device, there is a need for technology that can automatically read an identifier mounted to the object.

### BRIEF DESCRIPTION OF THE DRAWINGS

FIG. 1 is a schematic view showing a transport device according to an embodiment;

FIG. 2 is a side view showing a transport object and the transport device according to the embodiment;

FIG. 3 is a perspective view showing the transport object;

FIGS. 4A and 4B are schematic views showing an operation of the transport device according to the embodiment;

FIGS. 5A and 5B are schematic views showing an operation of the transport device according to the embodiment;

FIGS. 6A and 6B are schematic views showing an operation of the transport device according to the embodiment;

FIGS. 7A and 7B are schematic views showing an operation of the transport device according to the embodiment;

FIG. 8 is a flowchart illustrating the operation of the transport device according to the embodiment;

FIGS. 9A and 9B are perspective views showing a transport object;

FIGS. 10A and 10B are perspective views showing a transport object;

FIG. 11 is a side view showing a transport device according to a first modification of the embodiment;

FIG. 12 is a side view showing a transport device according to a second modification of the embodiment;

FIG. 13 is a plan view showing a transport device according to a third modification of the embodiment;

FIGS. 14A and 14B are schematic views showing an operation of the transport device according to the third modification of the embodiment;

FIG. 15 is a schematic view showing an operation of the transport device according to the third modification of the embodiment;

FIGS. 16A and 16B are schematic views showing a transport device according to a fourth modification of the embodiment; and

FIG. 17 is a schematic view illustrating a hardware configuration.

### DETAILED DESCRIPTION

According to one embodiment, a transport device includes a main part, a wheel, and a reader. The main part supports or pulls an object. The wheel is mounted to the main part, and rolls over a traveling surface. The reader is fixed with respect to the main part, and reads an identifier in a direction tilted with respect to a first direction and a second direction. The first direction is along the traveling surface, and the second direction is perpendicular to the traveling surface. The identifier is mounted to a surface, which crosses the first direction, of the object. A position of an area of the surface read by the reader changes along the second direction as the transport device moves in the first direction.

Various embodiments will be described hereinafter with reference to the accompanying drawings.

The drawings are schematic and conceptual; and the relationships between the thickness and width of portions, the proportions of sizes among portions, etc., are not necessarily the same as the actual values thereof. Further, the dimensions and proportions may be illustrated differently among drawings, even for identical portions.

In the specification and drawings, components similar to those described or illustrated in a drawing thereinabove are marked with like reference numerals, and a detailed description is omitted as appropriate.

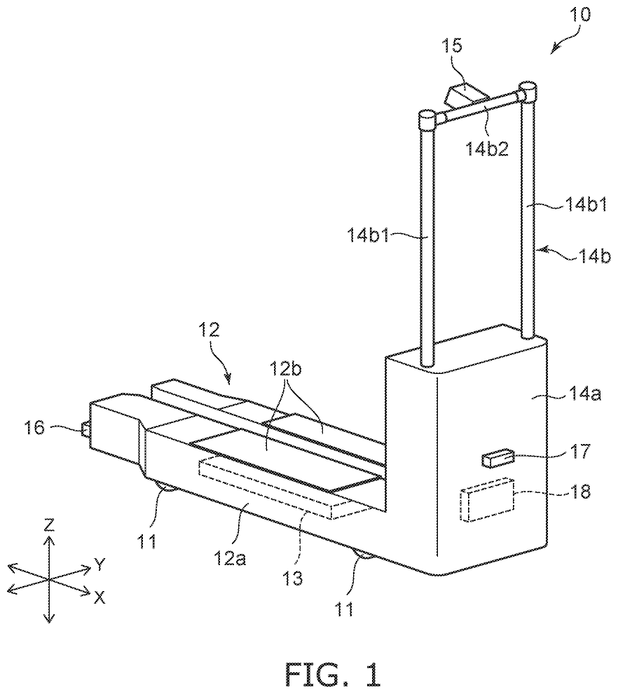

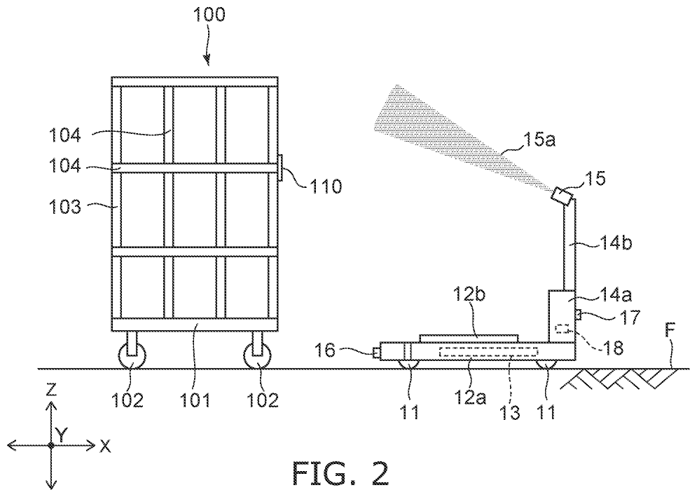

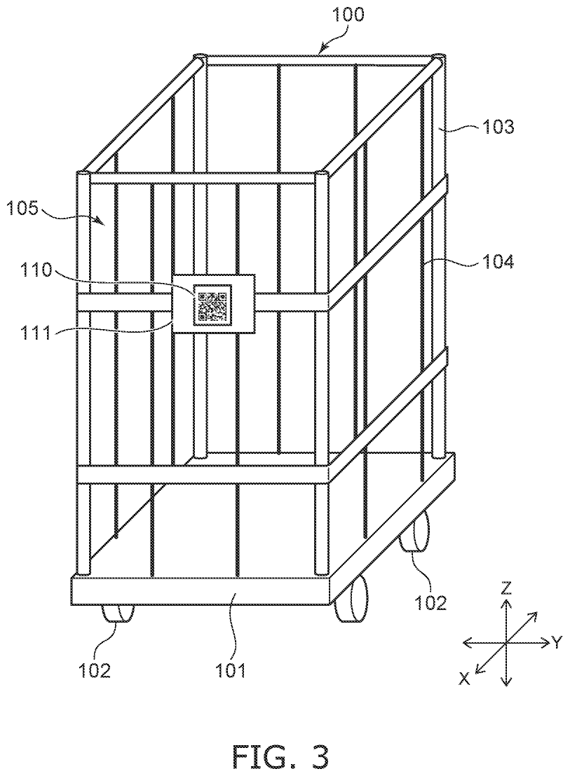

FIG. 1 is a schematic view showing a transport device according to an embodiment. FIG. 2 is a side view showing a transport object and the transport device according to the embodiment. FIG. 3 is a perspective view showing the transport object.

The transport device according to the embodiment is configured to move by traveling over a floor surface, and is configured to transport an object. The transport device 10 shown in FIGS. 1 and 2 includes a wheel 11, a main part 12, a drive mechanism 13, a housing 14a, a support member 14b, a reader 15, a detector 16, a detector 17, and a control device 18.

Herein, two directions that cross each other along a traveling surface are taken as an X-direction (a first direction) and a Y-direction (a third direction). A direction that crosses the traveling surface is taken as a Z-direction (a second direction). For example, the X-direction, the Y-direction, and the Z-direction are respectively parallel to an X-axis direction, a Y-axis direction, and a Z-axis direction. The X-axis direction, the Y-axis direction, and the Z-axis direction are mutually-orthogonal. The X-axis direction and the Y-axis direction are parallel to the horizontal plane; and the Z-axis direction is parallel to the vertical direction. Herein, a direction that is parallel to the X-direction from the main part 12 toward the housing 14a is taken as “front”, “frontward”, or “forward”. The opposite direction of frontward is taken as “back”, “backward”, or “behind”. Movement with the housing 14a positioned at the travel-direction side of the main part 12 is called “forward travel”. Movement with the main part 12 positioned at the travel-direction side of the housing 14a is called “backward travel”.

For example, the transport device 10 is an automated guided vehicle that is configured to move autonomously over a floor surface. Automated guided vehicles are automatic guided vehicles (AGVs) that travel along preset guides, or autonomous mobile robots (AMRs) that travel while estimating their positions without a guide. The wheel 11 is located at the lower portion of the main part 12 and rolls over the traveling surface. Multiple wheels 11 are mounted to the main part 12. For example, the multiple wheels 11 include a drive wheel and idler wheels; and the transport device 10 travels using a differential drive technique. The wheel 11 may include a steering wheel, etc. The multiple wheels 11 may be drive wheels that use special wheels; and the transport device 10 may be able to travel in all directions.

The main part 12 includes a vehicle body 12a and a lifting device (a raising/lowering device) 12b. The vehicle body 12a has a shape extending in the longitudinal direction and includes a flat upper surface. The multiple wheels 11 are mounted respectively to four locations at the lower portion of the vehicle body 12a. The lifting device 12b is located at a portion of the upper surface of the vehicle body 12a. The lifting device 12b includes an actuator and can be raised and lowered in the Z-direction. When the lifting device 12b is raised, the flat upper surface of the lifting device 12b moves upward with respect to the upper surface of the vehicle body 12a.

The drive mechanism 13 is located inside the vehicle body 12a and drives the wheels 11. The drive mechanism 13 is operated by power supplied from a not-illustrated battery located in the vehicle body 12a.

The housing 14a has a rectangular parallelepiped shape and is located at the front of the main part 12. The support member 14b is located on the housing 14a and extends upward. The support member 14b is connected to the housing 14a. In the illustrated example, the support member 14b includes a pair of posts 14b1 (first posts) extending in the vertical direction, and a post 14b2 (a second post) extending in the horizontal direction. The pair of posts 14b1 is positioned respectively at the two Y-direction ends of the transport device 10. In the support member 14b, the two ends of the post 14b2 extending in the horizontal direction are fixed respectively to the upper ends of the two posts 14b1 extending in the vertical direction. In this state, the lower ends of the two posts 14b1 of the support member 14b extending in the vertical direction are fixed and connected to the upper portion of the housing 14a.

The transport device 10 travels mainly by forward travel. For example, in general movement which includes transporting objects, the transport device 10 mainly travels forward. As necessary, backward travel also is possible in which the main part 12 is positioned at the travel-direction side of the housing 14a.

The reader 15 is configured to read an identifier and is mounted to the support member 14b. The reader 15 is positioned higher than the main part 12, the housing 14a, etc., in the transport device 10. Also, the reader 15 is positioned further frontward of the lifting device 12b in the transport device 10. Although the reader 15 is mounted to the post 14b2 in the illustrated example, the specific position of the reader 15 is modifiable as appropriate. The reader 15 may be mounted to the post 14b1 as long as the reader 15 is positioned higher than the main part 12, the housing 14a, etc., and positioned further frontward than the lifting device 12b.

The reader 15 is tilted with respect to the X-direction and the Z-direction. In other words, the reader 15 faces a direction rotated around the Y-direction with respect to the X-Y plane, and is configured to read an identifier positioned in an obliquely upward direction. The reader 15 reads an identifier located backward in the tilt direction that is tilted with respect to the X-direction and the Z-direction. It is favorable for the tilt of the tilt direction with respect to the X-Z plane to be small; for example, such a tilt is less than 5 degrees. Favorably, the tilt direction is perpendicular to the Y-direction. In the illustrated example, the reader 15 is tilted upward. The reader 15 can read an identifier located within a reading range 15a shown in FIG. 2.

The reader 15 may be fixed to the post 14b1 extending in the vertical direction. The height of the reader 15 is arbitrarily settable as long as the identifier can be read. In such a case as well, the reader 15 is tilted at a prescribed angle with respect to the X-direction and the Z-direction. The reader 15 reads in the tilt direction to read the identifier located ahead in the travel direction.

For example, the reader 15 is fixed to the support member 14b. The position of the reader 15 with respect to the main part 12 is fixed thereby. Therefore, even when operating the transport device 10, the position and orientation of the reader 15 in the transport device 10 substantially do not change. The tilt of the reading range 15a also does not change.

The identifier is a one-dimensional code (a barcode) or a two-dimensional code (a QR code (registered trademark)). The identifier may be a character string in which multiple characters are arranged. The identifier may include alphabet characters, numerals, etc. An identifier called an AR marker that is intended to be read by a camera may be used. The specific type of the reader 15 is determined according to the identifier. For example, when the identifier is a barcode, a barcode reader can be used as the reader 15. When the identifier is a QR code (registered trademark), a QR code (registered trademark) reader or a camera can be used as the reader 15. When the identifier is a character string, a camera can be used as the reader 15.

The detector 16 and the detector 17 are configured to detect objects around the transport device 10. The detector 16 is mounted to the back of the main part 12 and detects objects located behind the transport device 10. The detector 17 is mounted to the front of the housing 14a and detects objects located frontward of the transport device 10.

For example, the detector 16 and the detector 17 each include distance sensors. From the perspective of accuracy, it is favorable for the detector 16 and the detector 17 to include laser rangefinders (LRFs).

A LRF scans a laser beam and receives a reflected light reflected from the object. The LRF measures the distance to the surface of the object based on the phase difference of the reflected light, the arrival time difference, etc. The LRF scans in a prescribed angle range of the periphery in the horizontal direction, and measures distance data to the surfaces of the objects at multiple points in the periphery. The detector 16 and the detector 17 each detect the objects at the periphery based on the measurement results of the LRFs.

Or, the detector 16 and the detector 17 each may include cameras. The detector 16 and the detector 17 detect the objects at the periphery from the images that are imaged by the cameras. The cameras may include depth sensors in addition to image sensors.

The control device 18 is housed in the housing 14a and controls the operations of the components of the transport device 10. For example, the control device 18 moves the transport device 10 by operating the drive mechanism 13. The control device 18 raises the lifting device 12b and lowers the lifting device 12b. The control device 18 operates the detectors 16 and 17 and receives the detection result of the detector 16 and the detection result of the detector 17.

The transport device 10 can lift an object by positioning the main part 12 under the transport object and by raising the lifting device 12b. Here, an example in which the transport object is a cart as shown in FIGS. 2 and 3 will be described. More specifically, the cart is a basket-shaped “basket cart” that includes multiple fences.

As shown in FIGS. 2 and 3, the cart 100 includes a bottom plate 101, wheels 102, a frame body 103, and bars 104. The bottom plate 101 has a rectangular plate shape and is arranged horizontally. The wheels 102 are located respectively at the four corners of the lower surface of the bottom plate 101. The frame body 103 extends along the Z-direction at the four sides of the upper surface of the bottom plate 101. The bars 104 are arranged in a lattice shape inside the frame body 103. Fences are configured by the frame body 103 and the bars 104. The frame body 103 and the bars 104 are arranged to surround the space above the bottom plate 101. Packages can be loaded into the space surrounded with the bottom plate 101, the frame body 103, and the bars 104.

The cart 100 is transported by the transport device 10 moving while the cart 100 is lifted by the lifting device 12b. The raising/lowering device 12b raises the wheels 102 of the cart 100 away from a floor surface F. Or, the lifting device 12b may raise enough that the wheels 102 are not separated from the floor surface F. The application of the entire load of the cart 100 to the transport device 10 can be avoided thereby.

The transport device 10 lowers the lifting device 12b after moving the cart 100 to a prescribed location. The lifting device 12b separates from the bottom plate 101 of the cart 100; and the cart 100 is placed on the floor surface F. The transport of the cart 100 is completed thereby.

As shown in FIG. 3, an identifier 110 is mounted to the cart 100. For example, a holder 111 for storing the identifier 110 is adhered to a side surface 105 of the cart 100. The side surface 105 crosses the X-direction. The holder 111 is transparent. The identifier 110 is printed on paper; and a human inserts the identifier 110 into the holder 111.

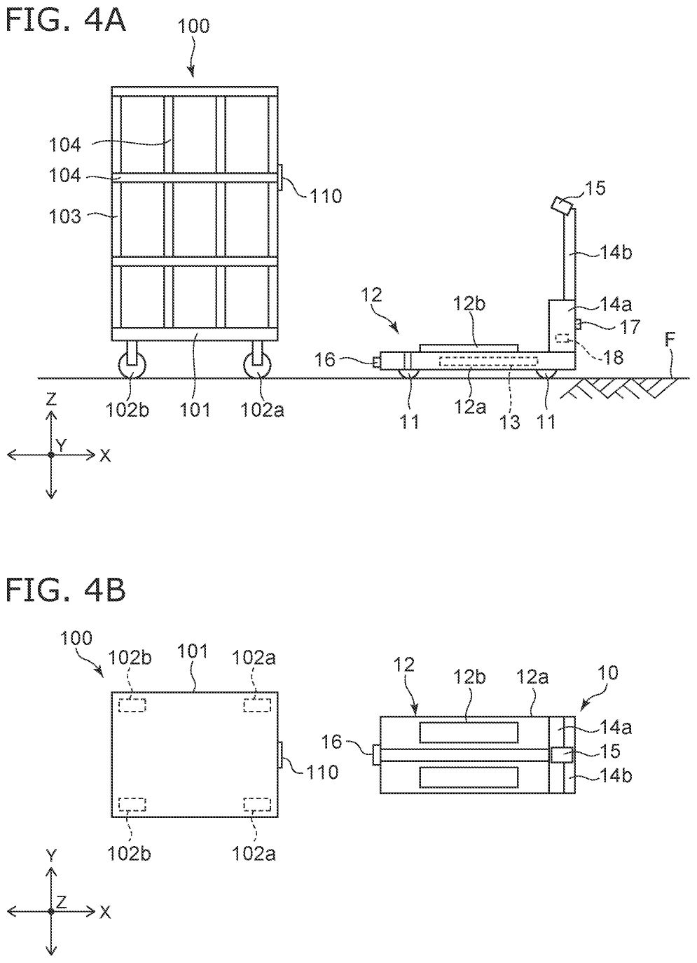

FIGS. 4A, 4B, 5A, 5B, 6A, 6B, 7A, and 7B are schematic views showing an operation of the transport device according to the embodiment.

First, the detector 16 or the detector 17 detects the cart 100. The control device 18 moves the transport device 10 by controlling the drive mechanism 13 based on the detection result of the detector 16 or the detector 17. Specifically, as shown in FIGS. 4A and 4B, the control device 18 moves the transport device 10 so that the transport device 10 and the cart 100 are arranged in the X-direction. At this time, the transport device 10 travels backward so that the main part 12 is positioned at the travel-direction side of the housing 14a. The cart 100 is positioned at the travel-direction (backward-travel-direction) side of the transport device 10. The transport device 10 also can rotate 180 degrees and travel with the housing 14a positioned at the travel-direction side of the main part 12.

As a more specific example, the control device 18 estimates the positions of the wheels 102 of the cart 100 based on the detection result of the detector 16. The multiple wheels 102 of the cart 100 include omni wheels 102a and fixed wheels 102b. A pair of omni wheels 102a is located at the front of the bottom plate 101. A pair of fixed wheels 102b is located at the back of the bottom plate 101. As shown in FIG. 4B, the control device 18 moves the transport device 10 so that the Y-direction position of the main part 12 moves between the Y-direction position of one omni wheel 102a and the Y-direction position of another omni wheel 102a.

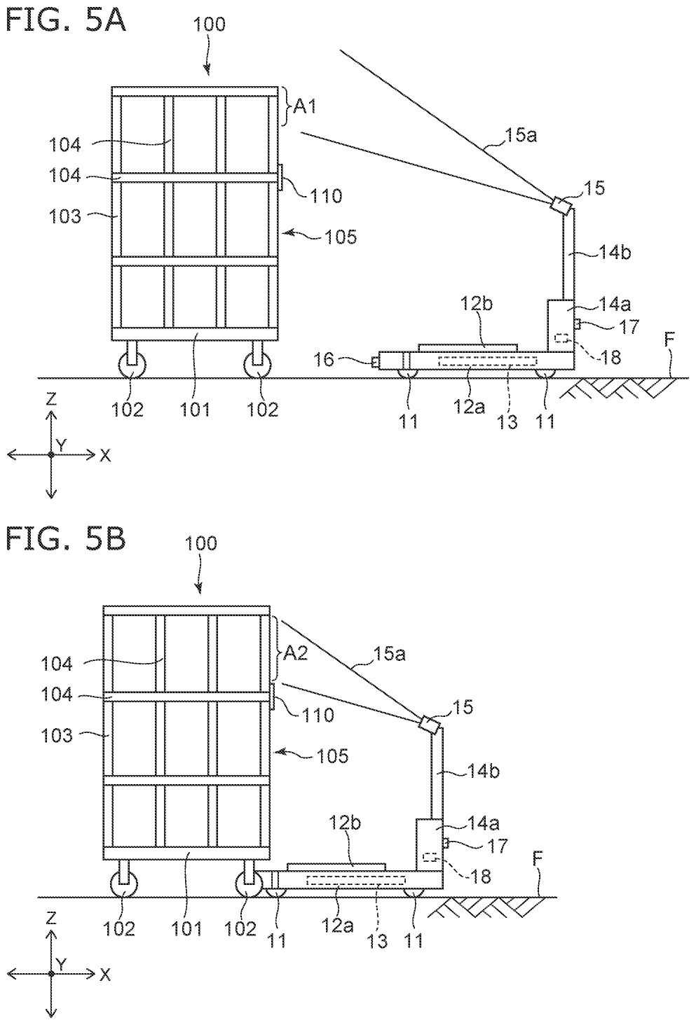

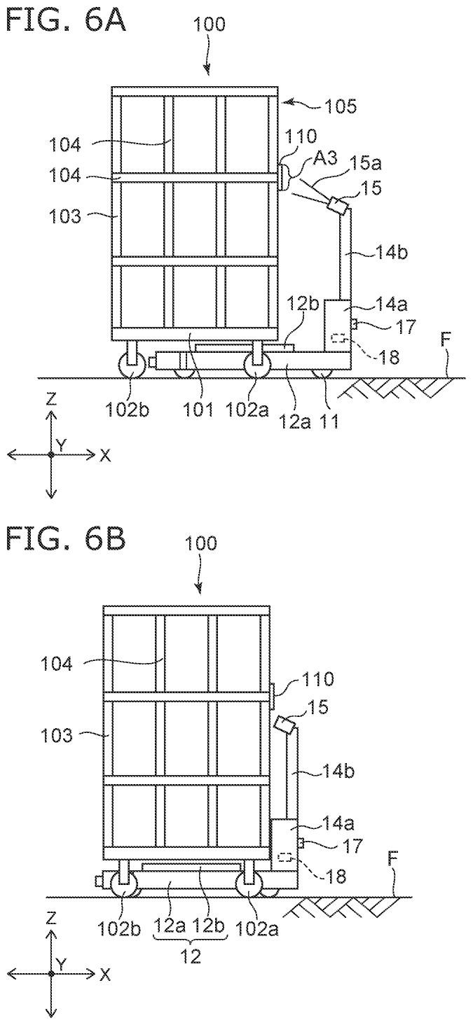

As shown in FIG. 5A, the control device 18 starts the reading by the reader 15 after the transport device 10 and the cart 100 are arranged in the X-direction. As shown in FIGS. 5A, 5B, and 6A, the control device 18 controls the drive mechanism 13 so that the transport device 10 travels backward toward the cart 100. The main part 12 moves along the X-direction between the omni wheels 102a.

In the state shown in FIG. 5A, an area A1 of the side surface 105 overlaps the reading range 15a. When the identifier 110 is located in the area A1, the identifier 110 is read by the reader 15 at the timing shown in FIG. 5A.

Similarly, an area A2 and an area A3 of the side surface 105 overlap the reading range 15a respectively in the states shown in FIGS. 5B and 6A. When the identifier 110 is located at the area A2, the identifier 110 is read at the timing shown in FIG. 5B. When the identifier 110 is located at the area A3, the identifier 110 is read at the timing shown in FIG. 6A. In the illustrated example, the identifier 110 is read at the timing shown in FIG. 6A because the identifier 110 is located at the area A3. Hereinbelow, the area of the side surface of the object read by the reader 15 is called the “reading area”.

The reader 15 is tilted with respect to the X-direction and the Z-direction. Therefore, as shown in FIGS. 5A, 5B, and 6A, the height (the Z-direction position) of the area read by the reader 15 changes according to the movement of the transport device 10 in the X-direction. Specifically, the area read by the reader 15 moves downward along the Z-direction as the transport device 10 moves toward the cart 100.

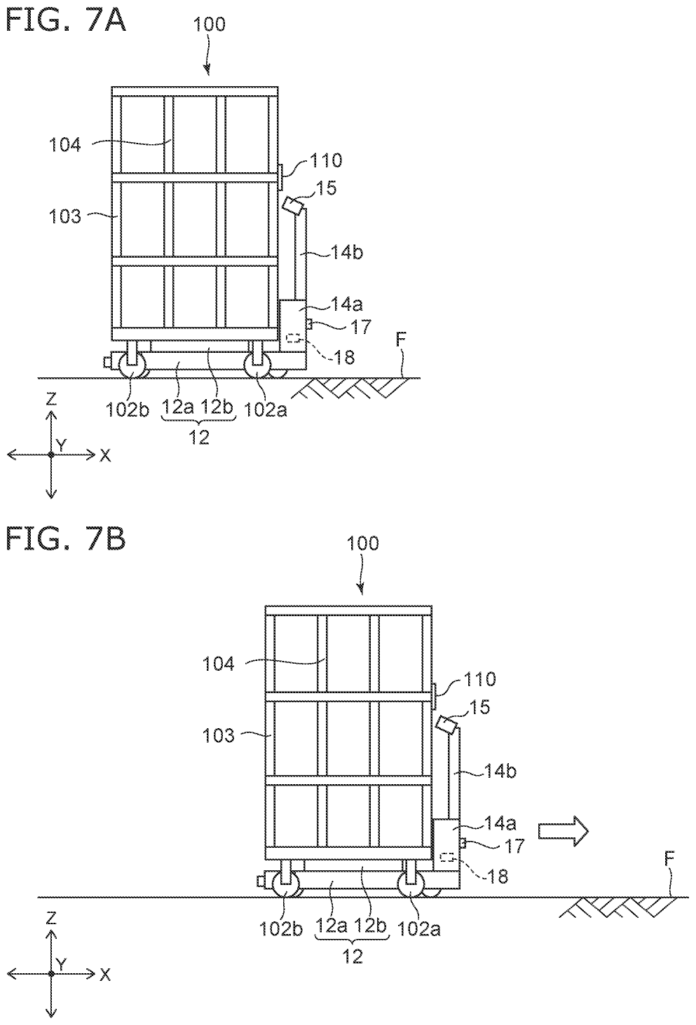

As shown in FIG. 6B, the control device 18 stops the transport device 10 when the main part 12 moves under the cart 100. As shown in FIG. 7A, the control device 18 raises the lifting device 12b and supports the cart 100 from below. As shown in FIG. 7B, the control device 18 causes the transport device 10 to travel forward while supporting the cart 100. The cart 100 is transported thereby.

The control device 18 ends the reading by the reader 15 when the identifier 110 is read by the reader 15 or when the lifting device 12b has moved below the cart 100 but the identifier 110 has not been read.

For example, the identifier 110 indicates the transport destination of the cart 100. When the identifier 110 is read by the reader 15, the control device 18 transports the cart 100 to the transport destination indicated by the identifier 110. When the identifier 110 is not read, the transport device 10 does not transport the cart 100. In such a case, the control device 18 may emit a notification. For example, the control device 18 transmits a message or an error code to a preregistered terminal device. The control device 18 may use sound, light, vibration, etc., to notify a human nearby that the identifier 110 was not read.

In addition to the transport destination, the identifier 110 may indicate identification data, the priority of the transport, etc., of the cart 100.

Advantages of the embodiment will now be described.

There are cases where the identifier 110 is mounted to the object to be transported. The identifier 110 is used to indicate the transport destination of the object. It is desirable to read the identifier 110 automatically instead of manually. To automatically read the identifier 110, it may be considered that the reader 15 should be located on the transport device 10 at the same horizontal height as the identifier 110 of the object. According to such a transport device, the identifier 110 can be read more reliably at an earlier timing. Also, the cost of the reader 15 can be reduced because the reader 15 having a narrow field of view can be used. On the other hand, there are cases where the transport device cannot read the identifier 110 when the heights of the identifiers 110 are different between the objects.

For this problem, it may be considered to move the area read by the reader 15 by moving the reader 15 in the vertical direction or by rotating the reader 15 around a rotation axis in the horizontal direction. However, in such a case, the transport device 10 becomes larger because a mechanism for moving or rotating the reader 15 is necessary. Also, it takes time to align the reading area. A control of the mechanism corresponding to the movement of the transport device 10 is necessary; and the sequence of the control is more complex. The cost of the transport device 10 also increases.

In the transport device 10 according to the embodiment, the reader 15 reads the identifier 110 in a tilt direction. According to the embodiment as shown in FIGS. 5A, 5B, and 6A, the height on the side surface 105 of the area read by the reader 15 changes according to the movement in the X-direction of the transport device 10. According to the embodiment, even when the heights of the identifiers 110 are different between the objects, the identifiers 110 of the objects can be read without using a mechanism to move or rotate the reader 15. The identifier 110 can be read automatically while suppressing a larger transport device 10 or a transport device 10 that has a more complex control. The position of the reading area changes automatically along the Z-direction according to the movement of the transport device 10. Therefore, alignment of the reading area also is unnecessary. The cost of the reader 15 also can be reduced because the identifier 110 can be read using the reader 15 having a narrow field of view.

For example, even when multiple types of carts 100 having different heights of the holders 111 are used, the reader 15 is mounted to the transport device 10 in a tilted arrangement, and the transport device 10 is caused to perform the operation shown in FIGS. 5A to 6A. As a result, the identifiers 110 of the carts 100 can be read by the reader 15. According to the embodiment, the reading of the identifier 110 can be automated even using an existing transport system that includes the transport device 10 and the cart 100.

The area in which the identifier 110 can be read becomes wider in the Z-direction as the tilt of the reader 15 with respect to the X-direction increases. On the other hand, when the tilt is too large, the reading accuracy may decrease. It is therefore favorable for the tilt to be greater than 5 degrees and less than 45 degrees.

It is favorable for the reader 15 to be positioned at substantially the Y-direction center of the transport device 10. For example, the reader 15 is located at the Y-direction center of the post 14b2. It is common for the holder 111 to be located at substantially the Y-direction center of the side surface of the cart 100. When the reader 15 is positioned at the Y-direction center of the transport device 10, the difference between the Y-direction position of the holder 111 and the Y-direction position of the reader 15 when the main part 12 moves between the wheels 102 of the cart 100 can be small. The identifier 110 can be read more reliably by the reader 15.

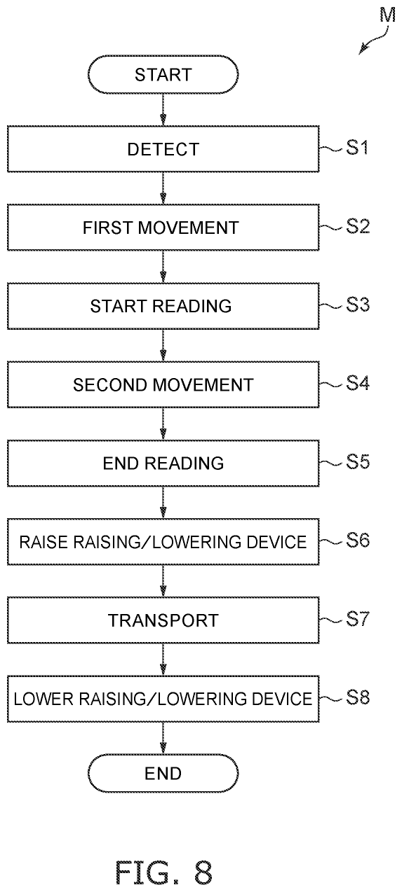

FIG. 8 is a flowchart illustrating the operation of the transport device according to the embodiment.

In a transport method M according to the embodiment, first, the transport device 10 moves toward the object to be transported. The transport object may be designated by a higher-level computer or may be designated by a human. The transport object may be determined by processing by the control device 18. The detector 16 or the detector 17 detects the object to be transported (step S1).

Based on the detection result of the detector 16 or the detector 17, the control device 18 moves the transport device 10 to a position that is arranged with the cart 100 in the X-direction (step S2: first movement). The control device 18 starts the reading by the reader 15 (step S3).

The control device 18 moves the transport device 10 in the X-direction toward the cart 100 (step S4: second movement). For example, the main part 12 passes between the wheels 102 of the cart 100 and moves under the cart 100. The control device 18 ends the reading by the reader 15 (step S5).

The control device 18 raises the lifting device 12b (step S6). The cart 100 is lifted thereby. The control device 18 transports the cart 100 by moving the transport device 10 (step S7). For example, the control device 18 transports the cart 100 to the transport destination indicated by the identifier 110. The control device 18 lowers the lifting device 12b (step S8). Thus, the transport is completed.

As shown in FIG. 5A, it is favorable for the reading by the reader 15 to be started after the first movement. It is difficult for the reader 15 to read the identifier 110 before or during the first movement; and useless operations of the reader 15 can be avoided. Also, an erroneous reading of another identifier 110 by the reader 15 before or during the first movement can be avoided.

As described above, the position of the reader 15 in the transport device 10 is fixed. The height of the identifier 110 can be calculated based on the height of the reader 15 and the positional relationship of the transport device 10 and the cart 100 when the identifier 110 is read. When the height of the identifier 110 (the holder 111) is different for each type of cart 100, the control device 18 may determine the type of the cart 100 based on the calculated height.

For example, when the transport destination of the cart 100 is designated according to the type of the cart 100, the control device 18 may compare the transport destination indicated by the identifier 110 with the transport destination corresponding to the determined type of the cart 100. The control device 18 may notify when these transport destinations are different. For example, the notification indicates that the identifier 110 stored in the holder 111 may be erroneous.

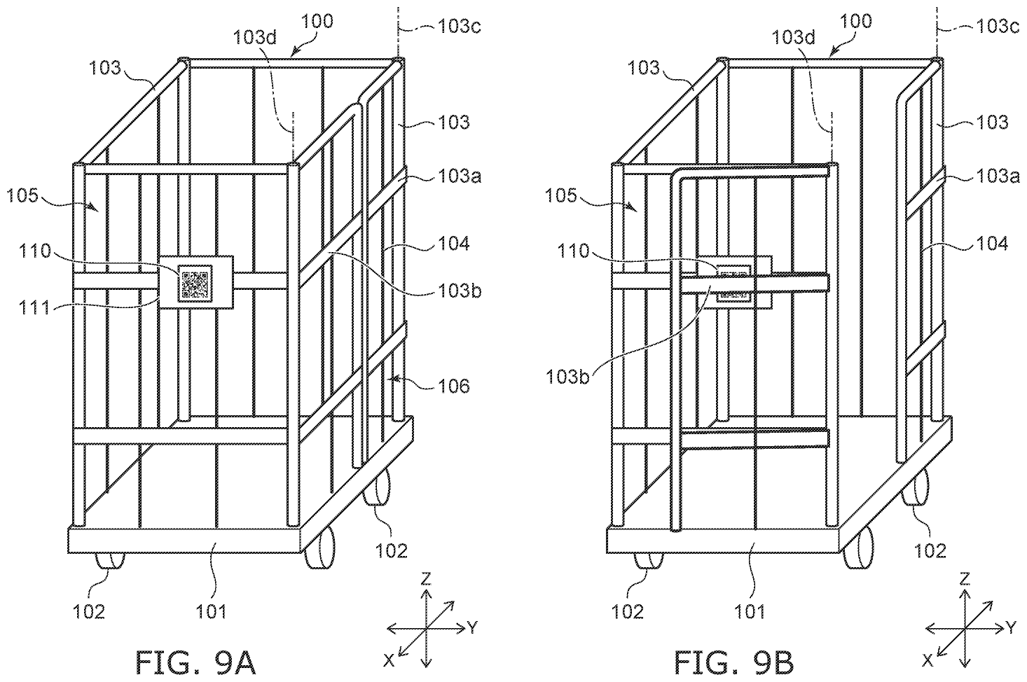

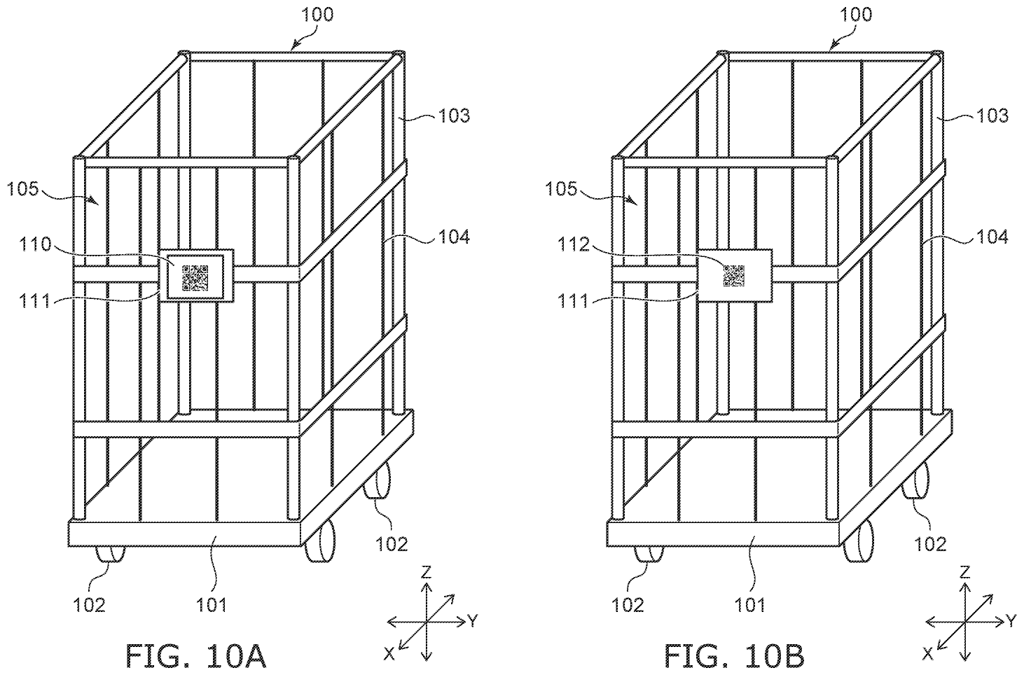

FIGS. 9A, 9B, 10A, and 10B are perspective views showing a transport object.

There are cases where a portion of the frame body 103 is rotatably mounted. For example, as shown in FIG. 9A, a frame body 103a and a frame body 103b of a side surface 106 facing the Y-direction are rotatable around the Z-direction respectively around a rotation axis 103c and a rotation axis 103d. The frame body 103a, the frame body 103b, and the bars 104 connected to these frame bodies form doors.

The cart 100 is transported with the doors in a closed state so that the articles loaded in the cart 100 do not fall. When a door is open as shown in FIG. 9B, the door may overlap the identifier 110. There is a possibility that the reader 15 may not be able to read the identifier 110. When the identifier 110 has not been not read even when the main part 12 has been moved below the cart 100, the control device 18 may determine that a door of the cart 100 is open. When it is determined that the door is open, the control device 18 emits a notification indicating that the door is open.

FIG. 10A shows a state in which the identifier 110 is mounted. FIG. 10B shows a state in which the identifier 110 is not mounted. As shown in FIG. 10B, an identifier 112 that is different from the identifier 110 may be located in the holder 111. For example, the identifier 112 is mounted to be positioned behind the identifier 110. In other words, when the identifier 110 is stored in the holder 111, the reader 15 can read the identifier 110 but cannot read the identifier 112. When the identifier 110 is not stored in the holder 111, the reader 15 can read the identifier 112.

In such a case, the control device 18 may determine the presence or absence of the identifier 110 according to whether or not the identifier 112 is read. When the identifier 112 is read and the identifier 110 is not read, the control device 18 determines that the identifier 110 is not mounted. The control device 18 may emit a notification indicating that there is no identifier 110. When neither the identifier 110 nor the identifier 112 is read, the control device 18 may determine that the reading by the reader 15 has failed or an abnormality of the reader 15 has occurred. The control device 18 may emit a notification indicating the failure or abnormality.

### First Modification

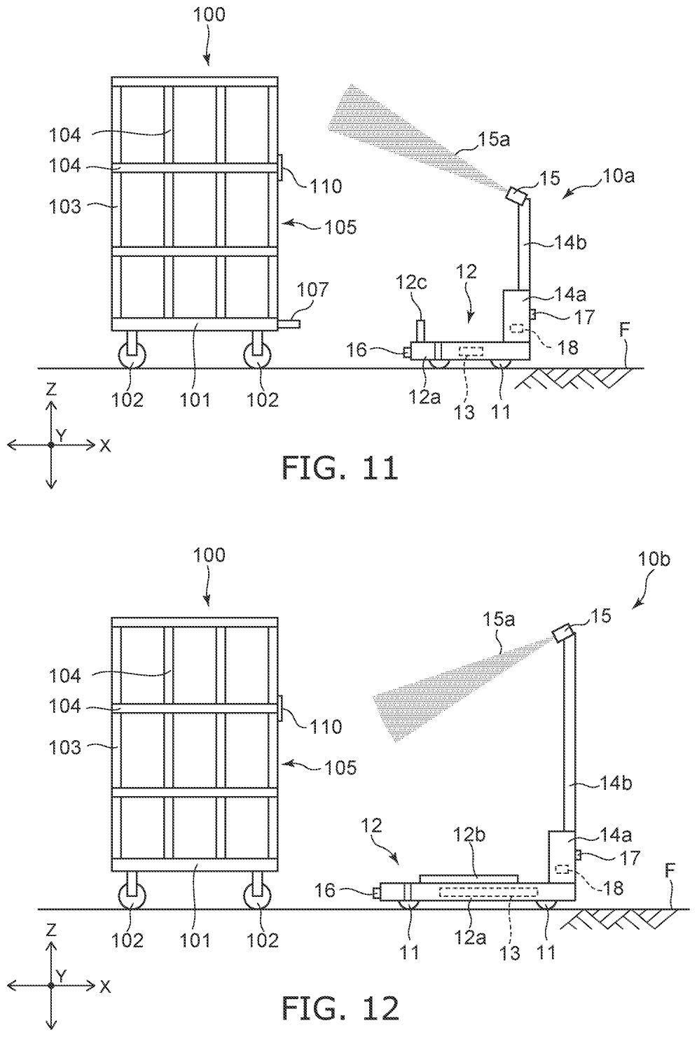

FIG. 11 is a side view showing a transport device according to the first modification of the embodiment.

The structure of the main part 12 of the transport device 10a shown in FIG. 11 is different from that of the transport device 10. In the transport device 10a, the main part 12 includes a coupler 12c instead of the lifting device 12b.

A coupler 107 is provided on the cart 100. The transport device 10a is connected to the cart 100 by the coupler 12c latching on the coupler 107. The control device 18 moves the transport device 10a in this state. The transport device 10a transports the object by pulling.

In the transport device 10a as well, the reader 15 is arranged to be tilted. Therefore, the height of the area of the side surface 105 read by the reader 15 changes according to the movement in the X-direction of the transport device 10a. As a result, even when the heights of the identifiers 110 are different between the objects, the identifier 110 can be read automatically without using a mechanism to move or rotate the reader 15.

### Second Modification

FIG. 12 is a side view showing a transport device according to a second modification of the embodiment.

Compared to the transport device 10, the reader 15 is located at a higher position in the transport device 10b according to the second modification shown in FIG. 12. For example, the reader 15 of the transport device 10b is located at a higher position than the reader 15 according to the embodiment described above with reference to FIG. 2. The reader 15 is tilted toward the obliquely downward direction. Therefore, the reading range 15a is positioned lower than the reader 15.

When the transport device 10b is used, the area of the side surface 105 read by the reader 15 moves upward along the Z-direction as the transport device 10b moves toward the cart 100. In other words, although the reading area of the reader 15 moves downward in the Z-direction according to the embodiment described above as shown in FIGS. 5A to 6B, according to the modification, the reading area moves in the opposite direction, i.e., upward in the Z-direction. Therefore, similarly to the transport device 10, even when the heights of the identifiers 110 are different between the objects, the identifier 110 can be read automatically without using a mechanism to move or rotate the reader 15.

From the perspective of downsizing, the transport device 10 is more favorable than the transport device 10b. By locating the reader 15 at a lower position, the support member 14b can be smaller, and the transport device 10 can be smaller.

### Third Modification

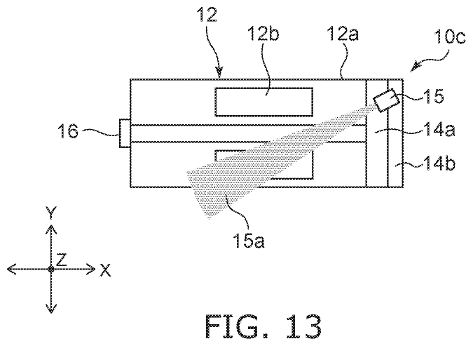

FIG. 13 is a plan view showing a transport device according to a third modification of the embodiment.

The orientation of the reader 15 of the transport device 10c according to the third modification shown in FIG. 13 is different from that of the transport device 10 described above. In the transport device 10, the reader 15 is tilted with respect to the X-direction and the Z-direction. In the transport device 10c, the reader 15 is tilted with respect to the X-direction and the Y-direction. The tilt of the tilt direction of the reader 15 with respect to the X-Y plane is small, e.g., less than 5 degrees. For example, the tilt direction is perpendicular to the Z-direction.

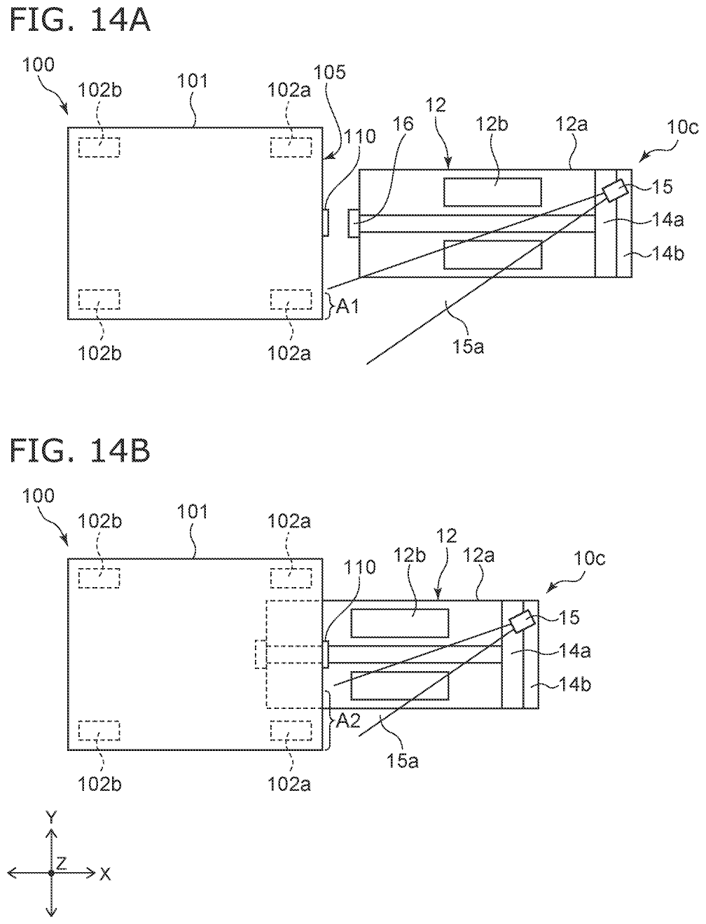

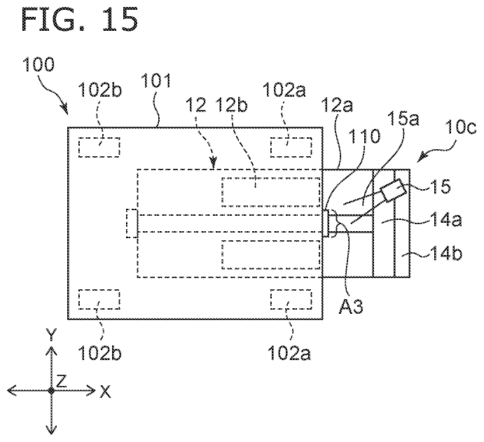

FIGS. 14A, 14B, and 15 are schematic views showing an operation of the transport device according to the third modification of the embodiment.

First, the transport device 10c moves to a position arranged with the cart 100 in the X-direction. As shown in FIG. 14A, the control device 18 starts the reading by the reader 15. As shown in FIG. 14B, the main part 12 moves along the X-direction and passes between the omni wheels 102a. As shown in FIG. 15, the main part 12 moves under the cart 100; and the transport device 10c stops.

When the transport device 10c is used, as shown in FIGS. 14A, 14B, and 15, the area of the side surface 105 read by the reader 15 moves along the Y-direction as the transport device 10c moves toward the cart 100. Even when the Y-direction positions of the identifiers 110 are different between the objects, the identifiers 110 can be read automatically without using a mechanism to move or rotate the reader 15.

It is favorable for the Y-direction position of the reader 15 to be shifted from the Y-direction center of the transport device 10. For example, the reader 15 is located at a position that is shifted from the Y-direction center of the post 14b2. It is common for the holder 111 to be located at substantially the Y-direction center. However, it is favorable for the position of the reading area to change due to fluctuation of the specific position of the holder 111 in each cart. When the main part 12 moves between the wheels 102 of the cart 100, the Y-direction center of the transport device 10 is substantially aligned with the Y-direction center of the cart 100. When the Y-direction position of the reader 15 is aligned with the Y-direction center of the transport device 10, there is a possibility that the reading area that changes according to the movement of the transport device 10 may not pass through the Y-direction center of the cart 100. When the Y-direction position of the reader 15 is shifted from the Y-direction center of the transport device 10, the reading area more reliably passes through the Y-direction center of the cart 100. The reader 15 can more reliably read the identifier 110.

### Fourth Modification

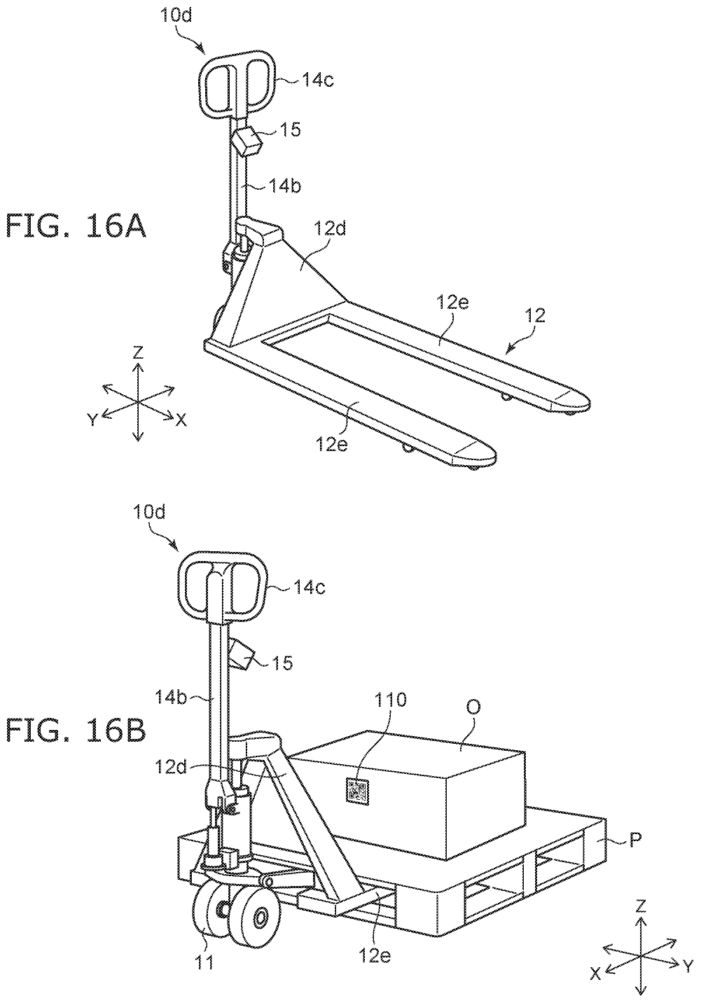

FIGS. 16A and 16B are side views showing a transport device according to a fourth modification of the embodiment.

The transport device 10d according to the fourth modification shown in FIGS. 16A and 16B includes the wheel 11, the main part 12, the support member 14b, a grip 14c, and the reader 15. The transport device 10d is a handlift.

The wheel 11 is mounted to the back of the main part 12. The main part 12 includes a stopper 12d and a fork 12e. The stopper 12d is a member that spreads along the Y-Z plane and suppresses movement in the X-direction of the object being transported. The fork 12e is located at the front of the stopper 12d and extends along the X-direction. The fork 12e is fixed with respect to the stopper 12d.

The support member 14b is located at the back of the stopper 12d and extends along the Z-direction. The support member 14b is positioned directly above the wheels 11. The grip 14c is located on the support member 14b. The human can operate the transport device 10d by gripping the grip 14c.

The reader 15 is mounted to the support member 14b or the grip 14c and is tilted with respect to the X-direction and the Z-direction. In the illustrated example, the reader 15 is tilted downward.

As shown in FIG. 16B, the transport device 10d can be used to transport an object O. First, the human moves the transport device 10d to a position that is arranged with a pallet P in the X-direction. Then, the transport device 10d is moved along the X-direction; and the fork 12e is inserted into the insertion slot of the pallet P. The pallet P and the object O are lifted by raising the fork 12e. The transport device 10d is moved while the pallet P is in the lifted state. The object O can be transported thereby.

The reader 15 moves in the X-direction with respect to the object O when the fork 12e is inserted into the pallet P. The identifier 110 is adhered to the side surface of the object O. The area on the side surface read by the reader 15 moves downward as the transport device 10d moves toward the object O.

According to the fourth modification, even when the Z-direction positions of the identifiers 110 are different between the objects O, the identifiers 110 can be read automatically by the movement of the transport device 10d without the human operating the reader 15.

The inventions according to the embodiments also are applicable to transport devices other than the examples described above. For example, the inventions according to the embodiments also are applicable to other transport devices such as forklifts, low lifts, etc. By applying the inventions according to the embodiments to such transport devices, the identifier can be read automatically while suppressing a larger transport device or a transport device that has a more complex control.

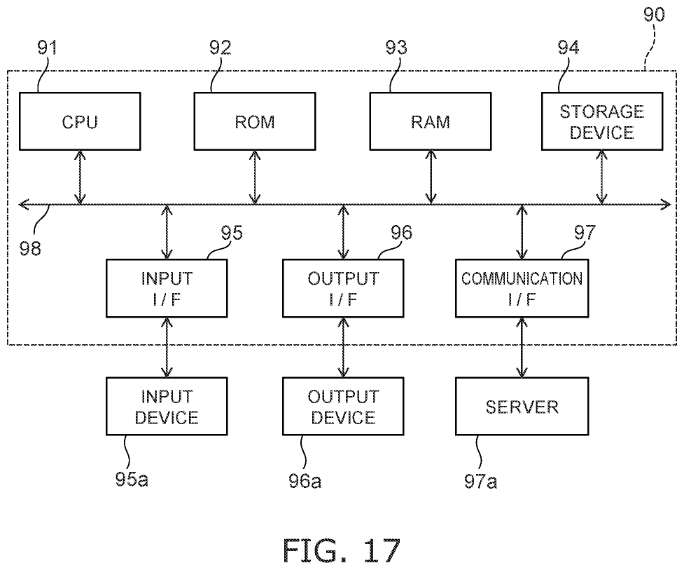

FIG. 17 is a schematic view illustrating a hardware configuration.

For example, a computer 90 shown in FIG. 17 is used as the control device 18. The computer 90 includes a CPU 91, ROM 92, RAM 93, a storage device 94, an input interface 95, an output interface 96, and a communication interface 97.

The ROM 92 stores programs that control the operations of the computer 90. Programs that are necessary for causing the computer 90 to realize the processing described above are stored in the ROM 92. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the storage device 94. When executing the programs, the CPU 91 executes various processing by controlling configurations via a system bus 98. The storage device 94 stores data necessary for executing the programs and/or data obtained by executing the programs.

The input interface (I/F) 95 can connect the computer 90 and an input device 95a. The input I/F 95 is, for example, a serial bus interface such as USB, etc. The CPU 91 can read various data from the input device 95a via the input I/F 95.

The output interface (I/F) 96 can connect the computer 90 and an output device 96a. The output I/F 96 is, for example, an image output interface such as Digital Visual Interface (DVI), High-Definition Multimedia Interface (HDMI (registered trademark)), etc. The CPU 91 can transmit data to the output device 96a via the output I/F 96 and cause the output device 96a to display an image.

The communication interface (I/F) 97 can connect the computer 90 and a server 97a outside the computer 90. The communication I/F 97 is, for example, a network card such as a LAN card, etc. The CPU 91 can read various data from the server 97a via the communication I/F 97.

The storage device 94 includes at least one selected from a hard disk drive (HDD) and a solid state drive (SSD). The input device 95a includes at least one selected from a mouse, a keyboard, a microphone (audio input), and a touchpad. The output device 96a includes at least one selected from a monitor, a projector, a printer, and a speaker.

The processing performed by the control device 18 may be realized by one computer 90 or may be realized by the collaboration of multiple computers 90.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD+R, DVD+RW, etc.), semiconductor memory, or another non-transitory computer-readable storage medium.

For example, the information that is recorded in the recording medium can be read by the computer (or an embedded system). The recording format (the storage format) of the recording medium is arbitrary. For example, the computer reads the program from the recording medium and causes a CPU to execute the instructions recited in the program based on the program. In the computer, the acquisition (or the reading) of the program may be performed via a network.

The embodiments may include the following configurations.

### (Configuration 1)

A transport device, comprising:
a main part supporting or pulling an object;
a wheel mounted to the main part, the wheel rolling over a traveling surface; and
a reader fixed with respect to the main part, the reader reading an identifier in a direction tilted with respect to a first direction and a second direction, the first direction being along the traveling surface, the second direction being perpendicular to the traveling surface, the identifier being mounted to a surface of the object, the surface crossing the first direction,
a position of an area of the surface read by the reader changing along the second direction as the transport device moves in the first direction.

### (Configuration 2)

The transport device according to Configuration 1, wherein
the main part includes a lifting device supporting the object from below, and
the lifting device is movable along the second direction.

### (Configuration 3)

The transport device according to Configuration 2, further comprising:
a detector,
the object including a pair of wheels arranged in a third direction,
the third direction crossing the first direction and being along the traveling surface,
the detector detecting the pair of wheels.

### (Configuration 4)

The transport device according to Configuration 3, further comprising:
a drive mechanism driving the wheel of the transport device; and
a control device controlling the drive mechanism.

### (Configuration 5)

The transport device according to Configuration 4, wherein
the control device controls the drive mechanism based on a detection result of the detector to cause the main part to move along the first direction between the pair of wheels.

### (Configuration 6)

The transport device according to Configuration 4, wherein
the control device performs:
   a first movement of moving the transport device to a position arranged with the object in the first direction; and
   a second movement of moving the transport device toward the object along the first direction after the first movement, and
the reader starts the reading after the first movement.

### (Configuration 7)

The transport device according to any one of Configurations 4 to 6, wherein
the control device determines a type of the object based on:
   a tilt of the reader with respect to the first direction; and
   a positional relationship of the object and the transport device when the identifier is read by the reader.

### (Configuration 8)

The transport device according to any one of Configurations 4 to 7, wherein
the object includes an other identifier,
the other identifier is different from the identifier, and
when the other identifier is read by the reader but the identifier is not read by the reader, the control device determines that the identifier is not mounted to the object.

### (Configuration 9)

The transport device according to any one of Configurations 4 to 8, wherein
the object is a cart including a door, and
when the identifier is not read by the reader, the control device determines that the door is open.

### (Configuration 10)

The transport device according to any one of Configurations 1 to 9, wherein
the reader includes at least one selected from a barcode reader and a camera.

### (Configuration 11)

The transport device according to any one of Configurations 1 to 10, further comprising:
a support member fixed with respect to the main part, the support member including
   a pair of first posts extending along the second direction, the pair of first posts being positioned respectively at two ends of the transport device in a third direction, the third direction crossing a plane parallel to the first and second directions, and
   a second post fixed to the pair of first posts, the second post extending along the third direction,
the reader being fixed to a center in the third direction of the second post.

### (Configuration 12)

The transport device according to any one of Configurations 1 to 11, wherein
the position of the area of the surface changes downward as the transport device moves in the first direction.

### (Configuration 13)

A transport device, comprising:
a main part supporting or pulling an object;
a wheel mounted to the main part, the wheel rolling over a traveling surface; and
a reader fixed with respect to the main part, the reader reading an identifier in a direction tilted with respect to first and third directions, the first and third directions crossing each other and being along the traveling surface, the identifier being mounted to a surface of the object, the surface crossing the first direction,
an area of the surface read by the reader changing along the third direction as the transport device moves in the first direction.

According to the embodiments described above, a transport device, an automated guided vehicle, a transport method, a control device, a control method and a storage medium, by which an identifier mounted to an object can be read automatically without moving or rotating a reader, are provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A transport device, comprising:
a main part supporting or pulling an object;
a wheel mounted to the main part, the wheel rolling over a traveling surface; and
a reader fixed with respect to the main part, the reader reading an identifier in a direction tilted with respect to a first direction and a second direction, the first direction being along the traveling surface, the second direction being perpendicular to the traveling surface, the identifier being mounted to a surface of the object, the surface crossing the first direction,
a position of an area of the surface read by the reader changing along the second direction as the transport device moves in the first direction.

2. The transport device according to claim 1, wherein
the main part includes a lifting device supporting the object from below, and
the lifting device is movable along the second direction.

3. The transport device according to claim 2, further comprising:
a detector,
the object including a pair of wheels arranged in a third direction,
the third direction crossing the first direction and being along the traveling surface,
the detector detecting the pair of wheels.

4. The transport device according to claim 3, further comprising:
a drive mechanism driving the wheel of the transport device; and
a control device controlling the drive mechanism.

5. The transport device according to claim 4, wherein
the control device controls the drive mechanism based on a detection result of the detector to cause the main part to move along the first direction between the pair of wheels.

6. The transport device according to claim 4, wherein
the control device performs:
a first movement of moving the transport device to a position arranged with the object in the first direction; and
a second movement of moving the transport device toward the object along the first direction after the first movement, and
the reader starts the reading after the first movement.

7. The transport device according to claim 4, wherein
the control device determines a type of the object based on:
a tilt of the reader with respect to the first direction; and
a positional relationship of the object and the transport device when the identifier is read by the reader.

8. The transport device according to claim 4, wherein
the object includes an other identifier,
the other identifier is different from the identifier, and
when the other identifier is read by the reader but the identifier is not read by the reader, the control device determines that the identifier is not mounted to the object.

9. The transport device according to claim 4, wherein
the object is a cart including a door, and
when the identifier is not read by the reader, the control device determines that the door is open.

10. The transport device according to claim 1, wherein
the reader includes at least one selected from a barcode reader and a camera.

11. The transport device according to claim 1, further comprising:
a support member fixed with respect to the main part, the support member including
a pair of first posts extending along the second direction, the pair of first posts being positioned respectively at two ends of the transport device in a third direction, the third direction crossing a plane parallel to the first and second directions, and
a second post fixed to the pair of first posts, the second post extending along the third direction,
the reader being fixed to a center in the third direction of the second post.

12. The transport device according to claim 1, wherein
the position of the area of the surface changes downward as the transport device moves in the first direction.

13. An automated guided vehicle moving along a traveling surface and supporting an object from below, the automated guided vehicle comprising:
a reader reading an identifier in a direction tilted with respect to a first direction and a second direction, the first direction being along the traveling surface, the second direction being perpendicular to the traveling surface, the identifier being mounted to a surface of the object, the surface crossing the first direction; and
a detector detecting at least one wheel of the object,
a reading area of the surface being changed along the second direction by the automated guided vehicle moving along the first direction to move between wheels of the object, the reading area being read by the reader.

14. A control device, comprising:
a reader reading an identifier in a direction tilted with respect to a first direction and a second direction, the first direction being along a traveling surface, the second direction being perpendicular to the traveling surface, the identifier being mounted to a surface of an object, the surface crossing the first direction; and
a detector detecting at least one wheel of the object,
the control device controlling an automated guided vehicle,
the automated guided vehicle being configured to move along the traveling surface and configured to support the object from below,
the control device changing a reading area of the surface along the second direction by moving a vehicle body of the automated guided vehicle along the first direction to move the vehicle body between wheels of the object, the reading area being read by the reader.

15. A control method of an automated guided vehicle,
the automated guided vehicle including:
a reader reading an identifier in a direction tilted with respect to a first direction and a second direction, the first direction being along a traveling surface, the second direction being perpendicular to the traveling surface, the identifier being mounted to a surface of an object, the surface crossing the first direction; and
a detector detecting at least one wheel of the object,
the automated guided vehicle being configured to move along the traveling surface and configured to support the object from below,
the method comprising:
changing a reading area of the surface along the second direction by moving a vehicle body of the automated guided vehicle along the first direction to move the vehicle body between wheels of the object, the reading area being read by the reader.

16. A non-transitory computer-readable storage medium storing a program,
the program causing a computer to function as the control device according to claim 15.
